(19) United States
(12) Patent Application Publication
(10) Pub. No.: US 2012/0304656 A1
(43) Pub. Date: Dec. 6, 2012

(54) COMBUSTION LINER AND TRANSITION PIECE

(75) Inventors: Patrick Benedict Melton, Horse Shoe, NC (US); Kevin Weston McMahan, Greer, SC (US); Arthur Samuel Peck, Greenville, SC (US); David William Cihlar, Greenville, SC (US)

(73) Assignee: GENERAL ELECTRIC COMPANY, Schenectady, NY (US)

(21) Appl. No.: 13/153,836

(22) Filed: Jun. 6, 2011

(51) Int. Cl. F23R 3/44; F16L 9/00

(52) U.S. Cl. 60/752; 138/177

(57) ABSTRACT

An apparatus is disclosed. The apparatus may include a body configured to flow hot gases of combustion between a forward end and an aft end. Additionally, the body may include a plurality of raised sections spaced apart circumferentially around an outer perimeter of the body. The raised sections may generally extend lengthwise between the forward and aft ends.

### FIELD OF THE INVENTION

The present subject matter relates generally to a combustion product receiving apparatus and, more particularly, to a combustion liner and/or a transition piece for a gas turbine combustor having a plurality of raised sections to enhance the cooling and manufacture of such component(s).

### BACKGROUND OF THE INVENTION

Combustors are known in the art for igniting fuel with air to produce combustion gases having high temperature and pressure. For example, gas turbine systems typically include multiple combustors that mix compressed working fluid from a compressor with fuel and ignite the mixture to produce hot gases of combustion. The hot gases then flow to a turbine where they expand to produce work.

Each gas turbine combustor typically includes a combustion liner that surrounds the combustion chamber to contain the working fluid and fuel during combustion and a transition piece coupled to the combustion liner for flowing the hot gases of combustion to the turbine. The temperatures associated with combustion often exceed 3500° F., and the combustion liner and transition piece typically have a maximum operating temperature on the order of approximately 1500° F. Therefore, various systems and methods have been developed to cool the combustion liner and transition piece. For example, the working fluid may be directed over the external surfaces of the combustion liner and transition piece prior to flow into the combustion chamber to provide film, convective and/or impingement cooling to such surfaces. However, despite this cooling arrangement, dynamic changes in pressure, temperatures and power loads may cause plastic deformation, bulging, or creep to occur in the combustion liner and/or transition piece over time, resulting in additional maintenance, repairs, and unplanned outages. For example, the combustion flame profile of the hot gases flowing through the combustion liner and transition piece may include hot and cold streaks that make it difficult to achieve uniform wall temperatures within such components, thereby leading to temperature induced stresses.

Accordingly, a combustion liner and/or a transition piece that has enhanced cooling characteristics would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter discloses an apparatus. The apparatus may include a body configured to flow hot gases of combustion between a forward end and an aft end. Additionally, the body may include a plurality of raised sections spaced apart circumferentially around an outer perimeter of the body. The raised sections may generally extend lengthwise between the forward and aft ends.

In another aspect, the present subject matter discloses a combustor. The combustor may include a combustion liner having a forward end and an aft end. The combustion liner may be configured to flow hot gases of combustion between the forward and aft ends. Additionally, the combustor may include a transition piece having a forward end and an aft end, with the forward end of the transition piece being coupled to the aft end of the combustion liner. Moreover, at least one of the combustion liner and the transition piece may include a plurality of raised sections spaced apart circumferentially from one another. The raised sections may generally extend lengthwise between at least one of the forward and aft ends of the combustion liner and the forward and aft ends of the transition piece.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a schematic depiction of one embodiment of a gas turbine;

FIG. 2 illustrates a cross-sectional, side view of one embodiment of a gas turbine combustor;

FIG. 3 illustrates a perspective view of one embodiment of a combustion liner in accordance with aspects of the present subject matter;

FIG. 4 illustrates a cross-sectional view of the combustion liner shown in FIG. 3 taken along line 4-4;

FIG. 5 illustrates a cross-sectional view of a portion of the combustion liner shown in FIG. 4;

FIG. 6 illustrates a perspective view of one embodiment of a transition piece in accordance with aspects of the present subject matter;

FIG. 7 illustrates a partial, cross-sectional view of the transition piece shown in FIG. 6 taken along line 7-7; and

FIG. 8 illustrates a perspective view of another embodiment of a combustion liner in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a combustion liner and/or a transition piece having varying wall thicknesses so as to provide beneficial cooling to such component(s) and/or to enhance the manufacturability of such components. For example, in several embodiments, the combustion liner and/or transition piece may include a plurality of raised sections and a plurality of thin sections, with the raised sections having a greater wall thickness than the thin sections. As such, the walls of the thin sections may be subject to enhanced cooling. Additionally, in several embodiments, the thin sections may generally be aligned with the hot streaks contained within the hot gases of combustion flowing through the combustion liner and/or the transition piece and the raised sections may generally be aligned with the cold streaks contained within the hot gases. As a result, a more uniform wall temperature may be achieved for the combustion liner and/or the transition piece as the thin sections may be cooled more effectively. Moreover, the raised sections may also allow for the combustion liner and/or transition piece to be more easily cast. For instance, the raised sections may allow for material to be fed to the thin sections during the casting process.

The present subject matter will generally be described herein with regard to a combustion liner and a transition piece for a gas turbine combustor. However, it should be appreciated that the present disclosure may be applied to any other suitable apparatus configured to confine and/or flow hot gases of combustion, whether or not such hot gases are contained within a gas turbine system.

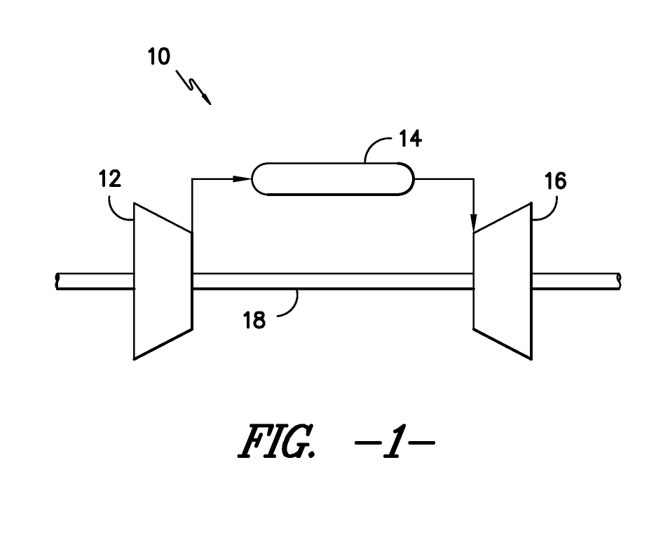

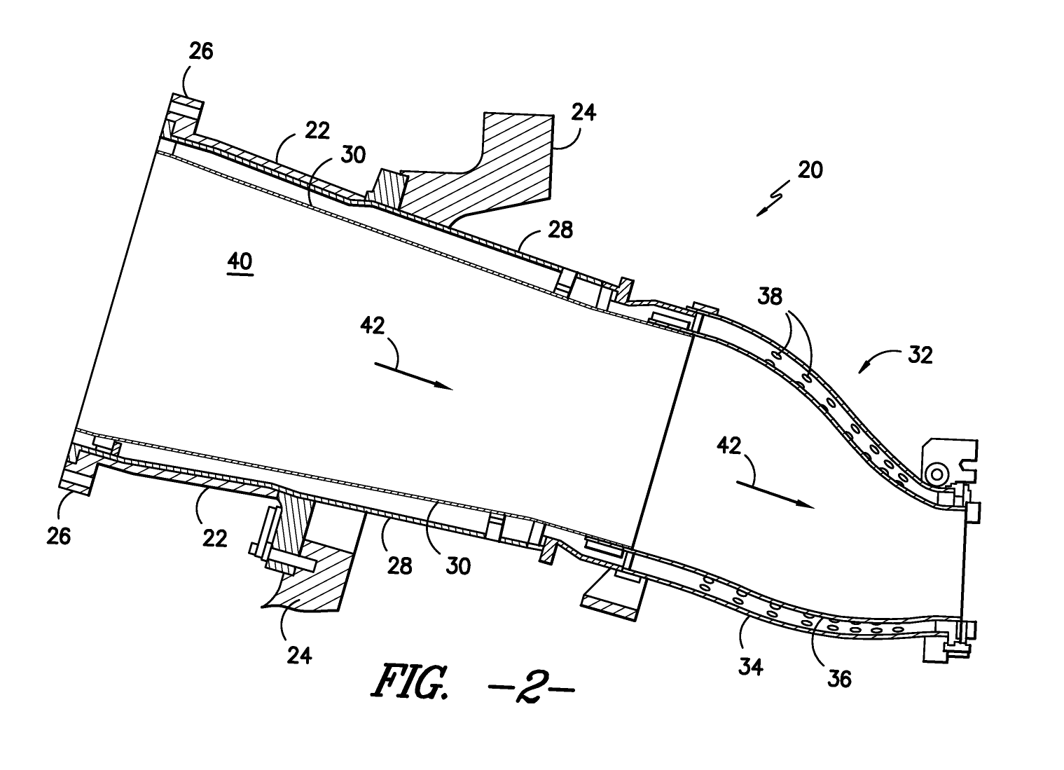

Referring now to the drawings, FIG. 1 illustrates a schematic depiction of a gas turbine 10. The gas turbine 10 includes a compressor section 12, a combustion section 14, and a turbine section 16. The combustion section 14 may include a plurality of combustors 20 (one of which is illustrated in FIG. 2) disposed in an annular array about the axis of the gas turbine 10. The compressor section 12 and turbine section 16 may be coupled by a shaft 18. The shaft 18 may be a single shaft or a plurality of shaft segments coupled together to form the shaft 18. During operation of the gas turbine 10, the compressor section 12 supplies compressed air to the combustion section 14. The compressed air is mixed with fuel and burned within each combustor 20 and hot gases of combustion flow from the combustion section 14 to the turbine section 16, wherein energy is extracted from the hot gases to produce work.

Referring to FIG. 2, a cross-sectional side view of one embodiment of a combustor 20 of the combustion section 14 of a gas turbine 10 is illustrated. The combustor 20 may generally include a substantially cylindrical combustion casing 22 secured to a portion of a gas turbine casing 24, such as a compressor discharge casing or a combustion wrapper casing. A flange 26 may generally extend outwardly from an upstream end of the combustion casing 22. The flange 26 may be configured such that an end cover assembly (not illustrated) may be secured to the combustion casing 22. As is generally known, the end cover assembly may include a plurality of fuel nozzles (not shown).

The combustor 20 may also include an internal flow sleeve 28 and a combustion liner 30 substantially concentrically arranged within the flow sleeve 28. Both the flow sleeve 28 and the combustion liner 30 may extend, at their downstream ends, to a double walled transition duct 32 including an impingement sleeve 34 and a transition piece 36 disposed within the impingement sleeve 34. It should be appreciated that the impingement sleeve 34 and the flow sleeve 28 may be provided with a plurality of air supply holes 38 over a portion of their surfaces, thereby permitting pressurized air from the compressor section 12 to enter the radial space between the combustion liner 30 and the flow sleeve 28. As such, the transition piece 36 and combustion liner 30 may be cooled as the pressurized air flows along such components towards the end cap assembly (not illustrated) of the combustor 20.

The combustion liner 30 may generally define a substantially cylindrical combustion chamber 40, wherein fuel and air are injected and combusted to produce hot gases of combustion (indicated by arrows 42). Additionally, the combustion liner 30 may be coupled at its downstream end to the transition piece 36 such that the combustion liner 30 and the transition piece 36 generally define a flowpath for the hot gases 42 flowing from each combustor 20 to the turbine section 16 of the gas turbine 10 (FIG. 1). As is generally understood, the hot gases 42 may have a swirling flowpath as they flow through both the combustion liner 30 and the transition piece 36.

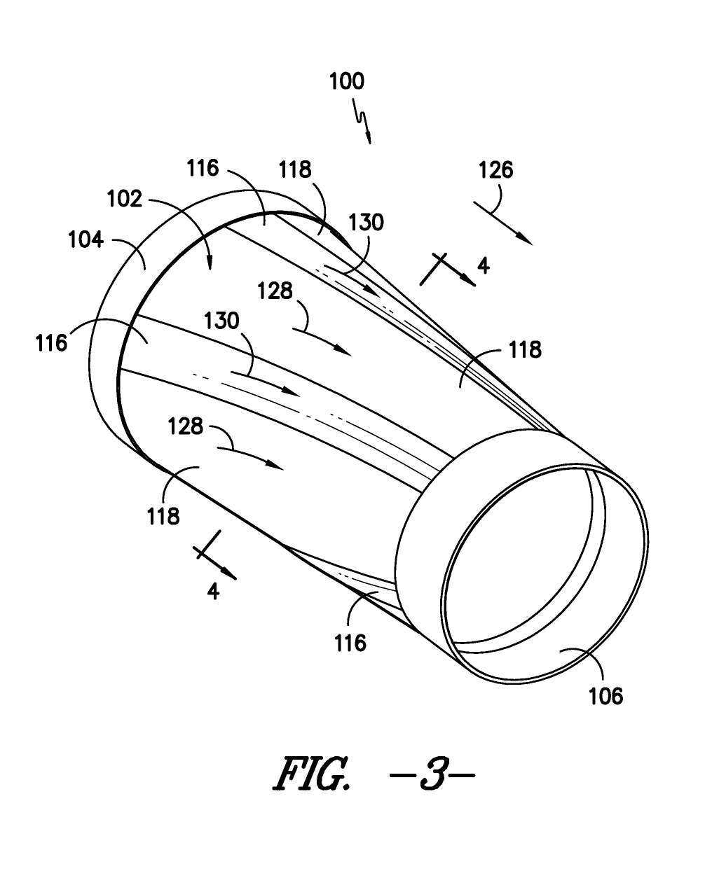

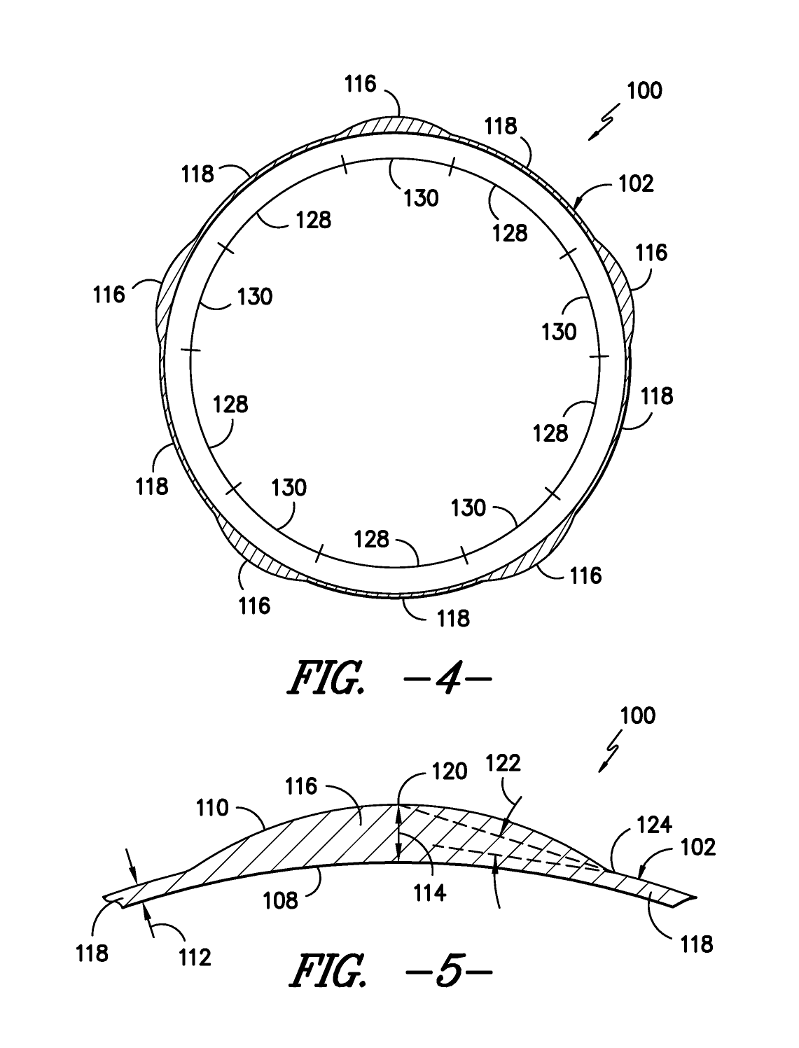

Referring now to FIGS. 3-5, one embodiment of a combustion liner 100 suitable for use within a combustor 20 (FIG. 2) of a gas turbine 20 is illustrated in accordance with aspects of the present subject matter. In particular, FIG. 3 illustrates a perspective view of the combustion liner 100. FIG. 4 illustrates a cross-sectional view of the combustion liner 100 shown in FIG. 3 taken along line 4-4. Additionally, FIG. 5 illustrates a cross-sectional view of a portion of the combustion liner 100 shown in FIG. 4.

As shown, the combustion liner 100 generally includes a body 102 for confining and directing the flow of hot gases of combustion from the combustion chamber 40 (FIG. 2) towards the transition piece 36, 200 (FIGS. 2, 6 and 7). In several embodiments, the body 102 may have a substantially cylindrical shape and may extend in a lengthwise direction (indicated by arrow 126) between a forward end 104 and an aft end 106. The forward end 104 may generally be configured to be disposed at and/or adjacent to the flange 26 (FIG. 2) or end cap assembly (not illustrated) of the combustor 20. As such, the forward end 104 may receive the mixture of fuel and air supplied by the fuel nozzles (not illustrated) of the combustor 20 so as to permit such mixture to be combusted within the combustion chamber 40. Additionally, the aft end 106 may generally be configured to be coupled to the transition piece 36, 200 using any suitable means known in the art (e.g., using a hula seal). Thus, the hot gases of combustion flowing through the body 102 may be directed through the aft end 106 and into the transition piece 36, 200 for subsequent flow to the turbine section 16 of the gas turbine 10 (FIG. 1).

As shown in FIG. 5, the body 102 may also include an inner surface 108 defining the inner perimeter of the combustion liner 100 and an outer surface 110 defining the outer perimeter of the combustion liner 100. Additionally, the body 102 may define a wall thickness 112, 114 between the inner and outer surfaces 108, 110. In several embodiments of the present subject matter, the wall thickness 112, 114 may generally be varied around the circumference of the body 102. For instance, as shown in the illustrated embodiment, the body 102 may include a plurality of raised sections 116 spaced apart circumferentially around the outer perimeter of the combustion liner 100 such that the wall thickness 112, 114 is varied around the body's circumference. Specifically, as shown in FIGS. 3-5, the raised sections 116 may be formed integrally with the body 102 and may comprise areas of increased wall thickness. Additionally, the raised sections 116 may be separated from one another by a plurality of thin sections 118 generally defining the substantially circular cross-sectional shape of the body 102 and being disposed co-annular, concentric and/or parallel to the raised sections 116. As such, the wall thickness 112, 114 may generally vary between a first wall thickness 112 (corresponding to the wall thickness of each thin section 118) and a second wall thickness 114 (corresponding to the wall thickness at a peak 120 of each raised section 116).

It should be appreciated that the first and second wall thicknesses 112, 114 may generally vary depending on numerous factors including, but not limited to, the particular configuration and/or operating conditions of the combustor 20 (FIG. 2) in which the combustion liner 100 is installed, the material used to form the combustion liner 100, the amount of cooling required and/or the particular configuration and/or scale of the combustion liner 100. However, in several embodiments of the present subject matter, the first wall thickness 112 may generally range from about 2 millimeters (mm) to about 6 mm, such as from about 2.25 millimeters to about 4.75 mm or from about 3 mm to about 4 mm and all other subranges therebetween. Additionally, in several embodiments, the second wall thickness 114 may generally range from about 4 mm to about 20 mm, such as from about 4.5 mm to about 9.5 mm or from about 9 mm to about 19 mm and all other subranges therebetween.

Additionally, as shown in FIG. 5, a transition angle 122 may generally be defined at an interface 124 between each thin section 118 and each raised section 116 around the outer perimeter of the combustion liner 100. Specifically, as shown, the transition angle 122 may be defined relative to a reference line extending tangentially to the outer surface 110 of the body 102 at each interface 124 and a reference line extending from each interface 124 to the peak 120 of each raised section 116, with the transition angle 122 corresponding to the angle between such reference lines. In several embodiments, the transition angle 122 may generally range from about 2 degrees to about 10 degrees, such as from about 2 degrees to about 8 degrees or from about 4 degrees to about 6 degrees and all other subranges therebetween. However, it is foreseeable that, in alternative embodiments, the transition angle 122 may correspond to an angle that is less than about 2 degrees or that is greater than about 10 degrees.

Referring still to FIGS. 3-5, each raised section 118 may generally be configured to extend in the lengthwise direction 126 between the forward and aft ends 104, 106 of the body. For instance, as shown in FIG. 3, the raised sections 118 may be formed in the body 102 so as to extend lengthwise between the forward and aft ends 104, 106 along a swirled or curvilinear path. In such an embodiment, each thin section 116 may also extend lengthwise between the forward and aft ends 104, 106 along a swirled or curvilinear path.

In several embodiments, the curvilinear paths defined by the thin and raised sections 118, 116 may be chosen so that the sections 118, 116 are thermally aligned with the flame profile of the hot gases of combustion flowing through the combustion liner 100. In particular, as is generally understood by those of ordinary skill in the art, the hot gases typically include a combustion flame profile having a plurality of hot areas or streaks (indicated by arrows 128 in FIG. 3 and lines 128 in FIG. 4) generally originating from the fuel nozzles (not shown) disposed at and/or adjacent to the forward end 104 of the combustion liner 100 and a plurality of relatively colder areas or streaks (indicated by arrows 130 in FIG. 3 and lines 130 in FIG. 4) separating the hot streaks 128. These hot and cold streaks 128, 130 generally define a swirling flowpath between the forward and aft ends 104, 106 of the combustion liner 100, thereby exposing curvilinear-shaped sections of the body 102 to differing temperature profiles. Thus, in a particular embodiment of the present subject matter, the body 102 may be formed so that each thin section 118 is generally aligned with one of the hot streaks 128 and each raised section 116 is generally aligned with one of the cold streaks 130. Such thermal alignment of the thin and raised sections 116, 118 may generally provide for enhanced cooling of the combustion liner 100. Specifically, since the thin sections 118 have a thinner wall thickness 112 than the raised sections 116, increased beneficial cooling may be provided to the areas of the combustion liner 100 exposed to the hottest temperatures. As such, the walls of the combustion liner 100 may exhibit a more uniform temperature distribution, thereby decreasing both the amount of thermally induced stresses and the pressure differential required for cooling.

It should be appreciated that, in alternative embodiments, the thin and raised sections 118, 116 need not define a swirled or curvilinear path, but may generally be configured to extend lengthwise between the forward and aft ends 104, 106 along any suitable path. For instance, due to the particular configuration of the components of a combustor, the hot and cold streaks 128, 130 may define a straight flowpath between the forward and aft ends 104, 106 of the combustion liner 100. In such an embodiment, as shown in FIG. 8, the thin and raised sections 118, 116 of the body 102 may be configured to extend lengthwise in a linear or straight path between the forward and aft ends 104, 106 of the combustion liner 100.

It should also be appreciated that the body 102 of the combustion liner 100 may generally include any suitable number of thin and raised sections 118, 116. For instance, in embodiments in which the thin and raised sections 118, 116 are designed to be aligned with the hot and cold streaks 128, 130 of the hot gases of combustion, the body 102 may include a number of thin and raised sections 118, 116 corresponding to the number of hot and cold streaks 128, 130 contained within the flow of hot gases. Thus, as shown in the illustrated embodiment, the body 102 may include five thin sections 118 and five raised sections 116 corresponding, for example, to the five hot streaks 128 and five cold streaks 130 created by a combustor 20 including five fuel nozzles (not illustrated) disposed in an annular array about its longitudinal axis.

Additionally, it should be appreciated that the raised sections 116 may be configured to extend lengthwise between the forward and aft ends 104, 106 of the combustion liner 100 along the entire length defined between such ends 104, 106 (as shown in FIGS. 3 and 8) or the raised sections 116 may be configured to extend lengthwise only partially between such ends 104, 106.

Moreover, the body 102 may generally be formed using any suitable means and/or material known in the art. For example, in one embodiment, the body 102 may be formed using a suitable casting process. In such an embodiment, the casting used to form the body 102 may be gated at the raised sections 116 to permit the thin sections 118 to be filled with material without creating excessive voids or inclusions, thereby providing for easier castability and allowing for an enhanced casting yield. Additionally, by using a casting process, the costs associated with manufacturing the combustion liner 100 may be reduced significantly.

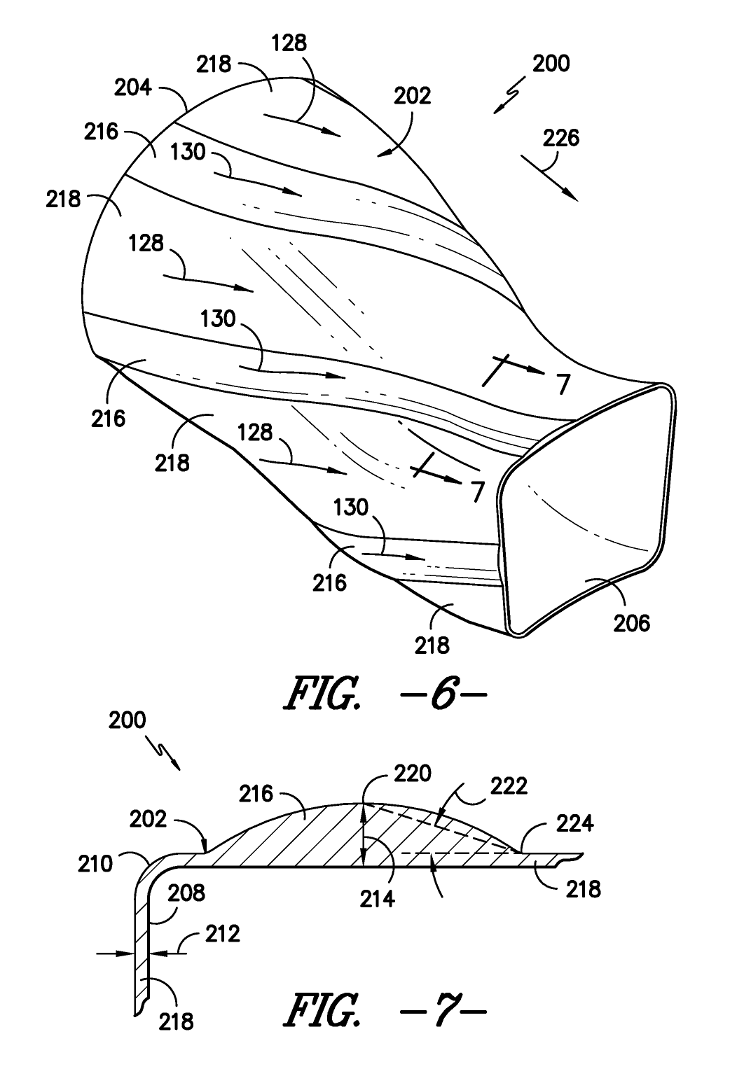

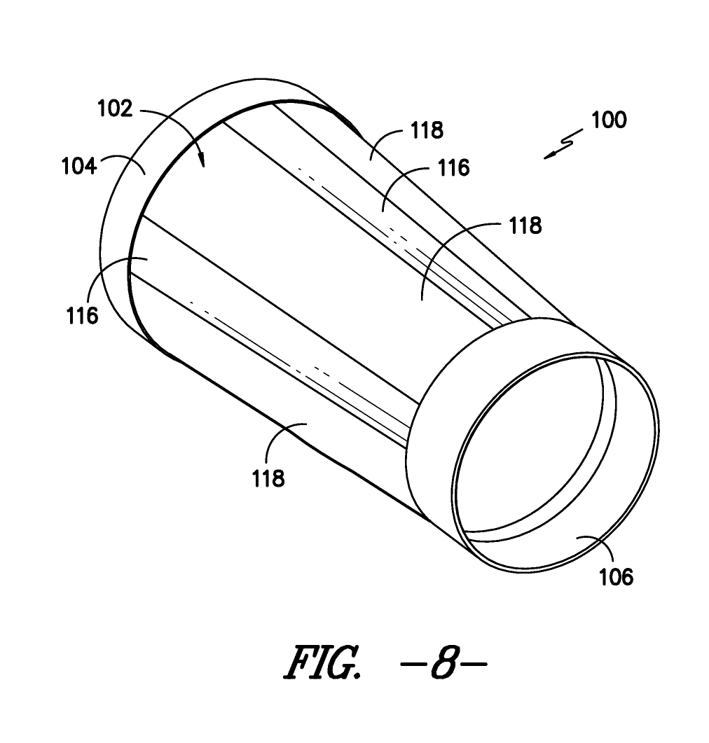

Referring now to FIGS. 6 and 7, one embodiment of a transition piece 200 suitable for use within a combustor 20 (FIG. 2) of a gas turbine 10 is illustrated in accordance with aspects of the present subject matter. In particular, FIG. 6 illustrates a perspective view of the transition piece 200. Additionally, FIG. 7 illustrates a partial, cross-sectional view of the transition piece 200 shown in FIG. 6 taken along line 7-7.

As shown, the transition piece 200 generally includes a body 202 for confining and directing the flow of combustion products from the combustion liner 30, 102 (FIGS. 2-5 and 8) to the turbine section 16 of the gas turbine 10 (FIG. 1). Thus, the body 202 may generally include a forward end 204 configured to be coupled to the aft end 106 (FIGS. 3 and 8) of the combustion liner 100 and an aft end 206 configured to be disposed at and/or adjacent to a portion of the turbine section 16 (e.g., a stage one nozzle (not illustrated) of the turbine section 16). Additionally, in several embodiments, the cross-sectional shape of the body 202 may generally vary between the forward and aft ends 204, 206. For instance, in one embodiment, the forward end 204 may generally define a circular cross-sectional shape, with the body 202 transitioning to a generally rectilinear cross-sectional shape at the aft end 206.

As shown in FIG. 7, the body 202 may also include an inner surface 208 defining the inner perimeter of the transition piece 200 and an outer surface 210 defining the outer perimeter of the transition piece 200. Additionally, the body 202 may define a wall thickness 212, 214 between the inner and outer surfaces 208, 210. In several embodiments of the present subject matter, the wall thickness 212, 214 may generally be varied around the circumference of the body 202. For instance, as shown in the illustrated embodiment, the body 202 may include a plurality of raised sections 216 spaced apart circumferentially around the outer perimeter of the transition piece 200 such that the wall thickness 212, 214 is varied around the body's circumference. Specifically, as shown in FIGS. 6 and 7, the raised sections 216 may be formed integrally with the body 202 and may comprise areas of increased wall thickness. Additionally, the raised sections 216 may be separated from one another by a plurality of thin sections 218 generally defining the overall cross-sectional shape of the transition piece 200. As such, the wall thickness 212, 214 may generally vary between a first wall thickness 212 (corresponding to the wall thickness of each thin section 218) and a second wall thickness 214 (corresponding to the wall thickness at a peak 220 of each raised section 216).

It should be appreciated that, similar to the wall thicknesses 112, 114 of the combustion liner 100 described above, the first and second wall thicknesses 212, 214 of the body 202 may generally vary depending on numerous factors including, but not limited to, the particular configuration and/or operating conditions of the combustor 20 (FIG. 2) in which the transition piece 200 is installed, the material used to form the transition piece 200, the amount of cooling required and/or the particular configuration and/or scale of the transition piece 200. However, in several embodiments of the present subject matter, the first wall thickness 212 may generally range from about 2 millimeters (mm) to about 6 mm, such as from about 2.25 millimeters to about 4.75 mm or from about 3 mm to about 4 mm and all other subranges therebetween. Additionally, in several embodiments, the second wall thickness 214 may generally range from about 4 mm to about 20 mm, such as from about 4.5 mm to about 9.5 mm or from about 9 mm to about 19 mm and all other subranges therebetween.

Additionally, as shown in FIG. 7, a transition angle 222 may generally be defined at an interface 224 between each thin section 218 and each raised section 216 around the outer perimeter of the transition piece 200. Specifically, as shown, the transition angle 222 may be defined relative to a reference line extending tangentially to the outer surface 210 of the body 202 at each interface 224 and a reference line extending from each interface 224 to the peak 220 of each raised section 216, with the transition angle 222 corresponding to the angle between such reference lines. In several embodiments, the transition angle 222 may generally range from about 2 degrees to about 10 degrees, such as from about 2 degrees to about 8 degrees or from about 4 degrees to about 6 degrees and all other subranges therebetween. However, it is foreseeable that, in alternative embodiments, the transition angle 222 may correspond to an angle that is less than about 2 degrees or that is greater than about 10 degrees.

Referring still to FIGS. 6 and 7, each thin and raised section 218, 216 may generally be configured to extend in a lengthwise direction (indicated by arrow 226) between the forward and aft ends 204, 206 of the body 202. For instance, as shown in FIG. 6, the thin and raised sections 216, 218 may be formed in the body 202 so as to extend lengthwise along a swirled or curvilinear path. In such an embodiment, similar to the combustion liner 100 described above, the curvilinear paths defined by the thin and raised sections 218, 216 may be chosen so that the sections 218, 216 are thermally aligned with the flame profile of the hot gases of combustion flowing between the forward and aft ends 204, 206 of the body 202. Specifically, as shown in FIG. 6, the hot streaks (indicated by arrows 128 in FIG. 6) and cold streaks (indicated by arrows 130 in FIG. 6) of the hot gases flowing through the combustion liner 100 may continue to be swirled as they are directed from the combustion liner 100 through the transition piece 200, thereby exposing curvilinear-shaped sections of the body 202 to differing temperature profiles. As such, the thin and raised sections 218, 216 may be formed in the body 202 so that each thin section 218 is generally aligned with one of the hot streaks 128 and each raised section 216 is generally aligned with one of the cold streaks 130, thereby enhancing the cooling of the transition piece 200 and providing a uniform wall temperature distribution within the transition piece 200.

It should be appreciated that, in alternative embodiments, the thin and raised sections 218, 216 need not define a swirled or curvilinear path, but may generally be configured to extend lengthwise between the forward and aft ends 204, 206 along any suitable path. For instance, due to the particular configuration of the components of a combustor, the hot and cold streaks 128, 130 may define a straight flowpath between the forward and aft ends 204, 206 of the transition piece 100. Thus, in such an embodiment, the thin and raised sections 218, 216 of the body 202 may be configured to extend lengthwise in a linear or straight path between the forward and aft ends 204, 206 of the transition piece 200.

It should also be appreciated that the body 202 may generally include any suitable number of thin and raised sections 216, 218. However, in embodiments in which the thin and raised sections 216, 218 are designed to be aligned with the hot and cold streaks 128, 130 of the hot gases of combustion, the body 202 may include a number of thin and raised sections 216, 218 corresponding to the number of hot and cold streaks 128, 130 within the flow of hot gases. For instance, when the illustrated transition piece 200 is utilized with the combustion liner 100 described above with reference to FIGS. 3-5, it may be desirable for the transition piece 200 and combustion liner 100 to include the same number of thin and raised sections 116, 216, 118, 218, with such sections being generally aligned with one another when the forward end 204 of the transition piece 200 is coupled to the aft end 106 of the combustion liner 100.

Additionally, it should be appreciated that the raised sections 216 may be configured to extend lengthwise between the forward and aft ends 204, 206 of the transition piece 200 along the entire length defined between such ends 204, 206 (as shown in FIG. 6) or the raised sections 216 may be configured to extend lengthwise only partially between such ends 104, 106.

Further, it should be appreciated that the body 202 may generally be formed using any suitable material and/or means known in the art. For example, in particular embodiment of the present subject matter, the body 202 may be formed using a suitable casting process. In such an embodiment, the casting used to form the body 202 may be gated at the raised sections 216 to permit the thin sections 218 to be filled with material without creating excessive voids or inclusions, thereby providing for easier castability and allowing for an enhanced casting yield. Additionally, by using a casting process, the costs associated with manufacturing the transition piece 200 may be reduced significantly.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An apparatus, comprising:
a body configured to flow hot gases of combustion between a forward end and an aft end, said body including a plurality of raised sections spaced apart circumferentially around an outer perimeter of said body,
wherein said plurality of raised sections generally extends lengthwise between said forward and aft ends.

2. The apparatus of claim 1, wherein each of said plurality of raised sections generally extends in a curvilinear path between said forward and aft ends.

3. The apparatus of claim 1, wherein each of said plurality of raised sections is formed in said body so as to be generally aligned with a cold streak of said hot gases of combustion.

4. The apparatus of claim 3, further comprising a plurality of thin sections spaced apart around said outer perimeter so as to separate said plurality of raised sections from one another, wherein each of said plurality of thin sections is formed in said body so as to be generally aligned with a hot streak of said hot gases of combustion.

5. The apparatus of claim 1, wherein each of said plurality raised sections generally extends in a straight path between said forward and aft ends.

6. The apparatus of claim 1, wherein each of said plurality of raised sections defines a wall thickness ranging from about 4 millimeters to about 20 millimeters.

7. The apparatus of claim 1, wherein each of said plurality of raised sections defines a transition angle ranging from about 2 degrees to about 10 degrees.

8. The apparatus of claim 1, further comprising a plurality of thin sections spaced apart around said outer perimeter so as to separate said plurality of raised sections from one another, wherein each of said plurality of thin sections defines a wall thickness ranging from about 2 millimeters to about 6 millimeters.

9. The apparatus of claim 1, wherein said body is configured as a combustion liner.

10. The apparatus of claim 1, wherein said body is configured as a transition piece.

11. A combustor comprising:
a combustion liner including a forward end and an aft end, said combustion liner being configured to flow hot gases of combustion between said forward and aft ends; and
a transition piece including a forward end and an aft end, said forward end of said transition piece being coupled to said aft end of said combustion liner,
wherein at least one of said combustion liner and said transition piece includes a plurality of raised sections spaced apart circumferentially from one another, said plurality of raised sections generally extending lengthwise between at least one of said forward and aft ends of said combustion liner and said forward and aft ends of said transition piece.

12. The combustor of claim 11, wherein each of said plurality of raised sections generally extends in a curvilinear path between said at least one of said forward and aft ends of said combustion liner and said forward and aft ends of said transition piece.

13. The combustor of claim 11, wherein each of said plurality of raised sections is formed in said at least one of said combustion liner and said transition piece so as to be generally aligned with a cold streak of said hot gases of combustion.

14. The combustor of claim 13, further comprising a plurality of thin sections separating each of said plurality of raised sections from one another, wherein each of said plurality of thin sections is formed in said at least one of said combustion liner and said transition piece so as to be generally aligned with a hot streak of said hot gases of combustion.

15. The combustor of claim 11, wherein each of said plurality raised sections generally extends in a straight path between said at least one of said forward and aft ends of said combustion liner and said forward and aft ends of said transition piece.

16. The combustor of claim 11, wherein each of said plurality of raised sections defines a wall thickness ranging from about 4 millimeters to about 20 millimeters.

17. The combustor of claim 11, wherein each of said plurality of raised sections defines a transition angle ranging from about 2 degrees to about 10 degrees.

18. The combustor of claim 11, further comprising a plurality of thin sections separating each of said plurality of raised sections from one another, wherein each of said plurality of thin sections defines a wall thickness ranging from about 2 millimeters to about 6 millimeters.

19. The combustor of claim 11, wherein said plurality of raised sections is formed in both of said combustion liner and said transition piece.

20. The combustor of claim 11, wherein at least one of said combustion liner and said transition piece is formed using a casting process.
